(19) United States
(12) Patent Application Publication
(10) Pub. No.: US 2024/0293826 A1
(43) Pub. Date: Sep. 5, 2024

(54) PROCESS FOR TREATING FINES STREAM DERIVED FROM WASTE PROCESSING FACILITIES

(71) Applicant: TORXX KINETIC PULVERIZER LIMITED, Hamilton (BM)

(72) Inventors: Nicolas BELANGER, Hamilton (BM); Michael DROLET, Hamilton (BM); Peter EVERSON, Hamilton (BM); Terri WARD, Hamilton (BM); Christopher MUELLER, King City (CA)

(21) Appl. No.: 18/573,103

(22) PCT Filed: Jun. 23, 2022
(86) PCT No.: PCT/CA2022/051011

§ 371 Date: Dec. 21, 2023

(30) Foreign Application Priority Data
Jun. 25, 2021 (CA) 3123240
Jan. 7, 2022 (CA) 3145069

(51) Int. Cl. B02C 23/10; B09B 3/35; B09B 101/25; B09B 101/50; B09B 101/60; B09B 101/75; B29B 17/02; B29B 17/04

(52) U.S. Cl. CPC B02C 23/10; B09B 3/35; B29B 17/02; B29B 17/0404; B09B 2101/25; B09B 2101/50; B09B 2101/60; B09B 2101/75; B29B 2017/0224; B29B 2017/0484

(57) ABSTRACT

A process for treating a fines stream in a material recover facility (MRF), comprising: providing an MRF fines stream comprising breakable material and ductile material: subjecting the MRF fines streams to a one-pass kinetic pulverization stage to produce a pulverized material comprising a size-reduced fraction derived from the breakable material and an oversized fraction derived from the ductile material; withdrawing the pulverized material from the kinetic pulverizer; and subjecting the pulverized material to separation to produce a size-reduced stream and an oversized stream. Also provided is a system comprising a kinetic pulverizer, a pulverizer conveyor and a screen operatively coupled to the pulverizer conveyor to receive a pulverized stream and produce a sized-reduced stream and an oversized stream. The system can also include a magnetic separator and a dust collection system respectively located upstream and downstream of the kinetic pulverizer.

### TECHNICAL FIELD

The technical field generally relates to waste processing facilities-such as materials recovery facilities (MRFs), as well as and composting and waste sorting facilities—and the processing of fines streams from such facilities.

### BACKGROUND

Waste processing in MRFs and other facilities typically results in a fines stream after removal of larger items and the fines stream is usually destined for landfill without further treatment or recovery. It has not been efficient to further treat such fines streams using conventional techniques.

### SUMMARY

According to one aspect, there is provided a process for treating a fines stream in a material recover facility (MRF), comprising: providing a MRF fines stream comprising: breakable material comprising glass, ceramics, drywall, shingles, rocks and/or aggregates; and ductile material comprising plastics; subjecting the MRF fines streams to a one-pass kinetic pulverization stage wherein the fines stream is fed into a kinetic pulverizer and subjected to self-collisions created by vortices within the kinetic pulverizer to produce a pulverized material comprising a size-reduced fraction derived from the breakable material and an oversized fraction derived from the ductile material; withdrawing the pulverized material from the kinetic pulverizer; and subjecting the pulverized material to separation to produce a size-reduced stream and an oversized stream.

In at least one embodiment, the fines stream is derived from municipal solid waste (MSW), or source separated recyclables.

In at least one embodiment, the fines stream is a compost overs stream.

In at least one embodiment, the fines stream comprises material below 2 inches in size.

In at least one embodiment, the kinetic pulverizer is operated at a rotation speed between 500 RPM to 1,200 RPM.

In at least one embodiment, the kinetic pulverizer is operated at a rotation speed between 700 RPM and 1,000 RPM.

In at least one embodiment, the kinetic pulverizer is operated such that the size-reduced fraction is substantially sand or silt sized particles.

In at least one embodiment, the fines stream has a moisture content between 10% and 50% upon entry into the kinetic pulverizer.

In at least one embodiment, the fines stream has a moisture content between 15% and 40% upon entry into the kinetic pulverizer.

In at least one embodiment, the fines stream is not subjected to a drying stage upstream of the kinetic pulverization stage.

In at least one embodiment, the size-reduced fraction is a homogeneous mixture in the pulverized output stream.

In at least one embodiment, the kinetic pulverization stage effects water removal on the fines stream such that the water removal is between 5% and 8% in the kinetic pulverization stage.

In at least one embodiment, the kinetic pulverization stage and the separation enable the size-reduced stream to have a moisture content that is 5% to 30% lower than that of the fines stream.

In at least one embodiment, the kinetic pulverization stage effects pathogen reduction on the fines stream via air stripping.

In at least one embodiment, the process further comprises incorporating a friable additive into the fines stream such that the friable additive is size reduced and is homogenized with the breakable material to form part of the size-reduced fraction.

In at least one embodiment, the friable additive comprises a porosity agent, a soil additive, a building material additive, a compost additive, peat moss, or a glass product additive.

In at least one embodiment, the friable additive is introduced into the fines stream upstream of the kinetic pulverization stage.

In at least one embodiment, the friable additive is introduced directly into the kinetic pulverizer as a separate stream from the fines stream.

In at least one embodiment, the separation stage comprises screening.

In at least one embodiment, the screening is performed using a trommel screen.

In at least one embodiment, the screening is performed using a vibrating screen.

In at least one embodiment, the separation stage comprises a single screen.

In at least one embodiment, the process further comprises: monitoring at least one feed parameter of the fines stream and/or output parameter of the pulverized material, the oversized stream and/or the size-reduced stream; and adjusting the one-pass kinetic pulverization stage based on the feed parameter and/or the output parameter.

In at least one embodiment, the at least one feed parameter comprises feed rate of the fines stream and/or composition of the fines stream.

In at least one embodiment, the at least one output parameter comprises size properties of the sized-reduced fraction in the pulverized stream, composition of the pulverized stream, flow rate of the oversized stream, flow rate of the sized-reduced stream, composition of the oversized stream, and/or composition of the sized-reduced stream.

In at least one embodiment, the adjusting of the one-pass kinetic pulverization stage comprises adjusting the rotation speed.

In at least one embodiment, the adjusting of the one-pass kinetic pulverization stage comprises adjusting the infeed rate of the fines stream.

According to another aspect, there is also provided a process for treating a fines stream derived from waste material, comprising: providing a fines stream comprising: breakable material comprising glass, ceramics, drywall, shingles, rocks and/or aggregates; and ductile material comprising plastics; wherein the fines stream is substantially composed of material having a maximum size of 2 or 4 inches; subjecting the fines streams to a one-pass kinetic pulverization stage wherein the fines stream is fed into a kinetic pulverizer and subjected to self-collisions created by vortices within the kinetic pulverizer to produce a pulverized material comprising a size-reduced fraction derived from the breakable material and an oversized fraction derived from the ductile material; withdrawing the pulverized material from the kinetic pulverizer; and subjecting the pulverized material to separation to produce a size-reduced stream and an oversized stream.

In at least one embodiment, the fines stream is derived from source separated single stream material recovery facility (MRF).

In at least one embodiment, the fines stream comprises between 40% and 60% glass, and the size-reduced stream is composed of over 95%, 96%, 97%, 98% or 99% glass.

In at least one embodiment, the fines stream is derived from a mixed waste material recovery facility (MRF).

In at least one embodiment, the fines stream comprises between 50% and 70% organics, and the size-reduced stream is composed substantially of organics with at most 0.5-2% visible contaminants with a size above 4 mm.

In at least one embodiment, the fines stream is derived from a composting facility and comprises compost overs.

In at least one embodiment, the size-reduced stream is composed substantially of organics with at most 0.5-2% visible contaminants with a size above 4 mm.

In at least one embodiment, the process further comprises adding a friable additive to the fines stream for size reduction and homogenization with the size-reduced fraction.

In at least one embodiment, the friable additive is introduced into the fines stream upstream of the pulverization stage.

In at least one embodiment, the friable additive is introduced directly into the kinetic pulverizer.

In at least one embodiment, the process further comprises one or more features as recited above.

According to yet another aspect, there is also provided a system comprising: a kinetic pulverizer configured to receive and process a fines stream to produce a pulverized material; a pulverizer conveyor configured to transport the pulverized material downstream; a screen operatively coupled to the pulverizer conveyor and configured to receive the pulverized stream and produce a sized-reduced stream and an oversized stream.

In at least one embodiment, the system further comprises: a material recovery facility (MRF) that generates the fines stream; a fines conveyor configured to transport the fines stream to the kinetic pulverizer.

In at least one embodiment, the system further comprises one or more features as recited above or as described herein.

In at least one embodiment, the process and/or system also includes magnetic separation of the fines stream prior to the kinetic pulverization.

In at least one embodiment, the process and/or system also includes dust collection associated at least with the pulverized material that exits the kinetic pulverization stage.

### BRIEF DESCRIPTION OF FIGURES

FIG. 1 is a process flow diagram for treating a waste stream using kinetic pulverization followed by screening.

FIG. 2 is a left-side perspective view of a pulverizing apparatus, showing a motor and a housing for the pulverizing apparatus, according to an embodiment.

FIG. 3 is a right-side perspective view of the pulverizing apparatus illustrated in FIG. 2, showing an outlet proximate the bottom end of the housing.

FIG. 4 is a bottom perspective view of the pulverizing apparatus illustrated in FIG. 2, showing a belt connection connecting the motor and a rotatable shaft.

FIG. 5 is a section view of the housing illustrated in FIG. 3, showing the rotatable shaft and rotors positioned within the housing.

FIG. 6 is a partially exploded view of the housing for the pulverizing apparatus illustrated in FIG. 2.

FIG. 7 is a top sectional view of the housing for the pulverizing apparatus illustrated in FIG. 2, showing a plurality of deflectors spaced about the rotatable shaft along the housing sidewall.

FIG. 8 is a section view of the housing shown in FIG. 5 with the rotatable shaft and rotors removed therefrom, showing shelves positioned along the sidewall at different levels within the housing.

FIG. 9 is a partially sectioned view of a pulverizing rotor mounted within the housing for the pulverizing apparatus illustrated in FIG. 2, showing the vortices created within the housing.

FIG. 10 is a schematic top view of the housing according to an embodiment, showing overlapping vortices within the interior chamber of the housing.

FIG. 11 is a process flow diagram for treating multiple fines streams generated by a waste processing plant and using kinetic pulverization followed by separation.

FIG. 12 is a process flow diagram for treating a waste stream using kinetic pulverization followed by screening, and also including a magnetic separation stage and a dust collection stage.

FIG. 13 is a process flow diagram for treating a waste stream using kinetic pulverization followed by screening, and also including a dust collection stage.

FIG. 14 is a side view schematic of an example magnetic separation stage.

FIG. 15 is a side view schematic of another example of a magnetic separation stage.

### DETAILED DESCRIPTION

The treatment of fines streams derived from waste processing can include a one-pass pulverization stage through a kinetic pulverizer where breakable material is sized-reduced and ductile material is liberated and remains as an oversized fraction. The pulverized material is then subjected to a separation stage, which may include screening, to separate the oversized material from the broken-down sized material. The separated oversized material, which is largely plastics and other non-organic material, can then be disposed of, converted to fuel, or further separated to recover sub-fractions depending on its composition. The sized material can be repurposed in various applications, e.g., as a compost additive or feedstock, land applications such as topsoil, soil amendment, fill, building material additive, and so on, depending on its size and composition properties. For some implementations, the sized material can be subjected to additional treatments, such as composting or anaerobic digestion.

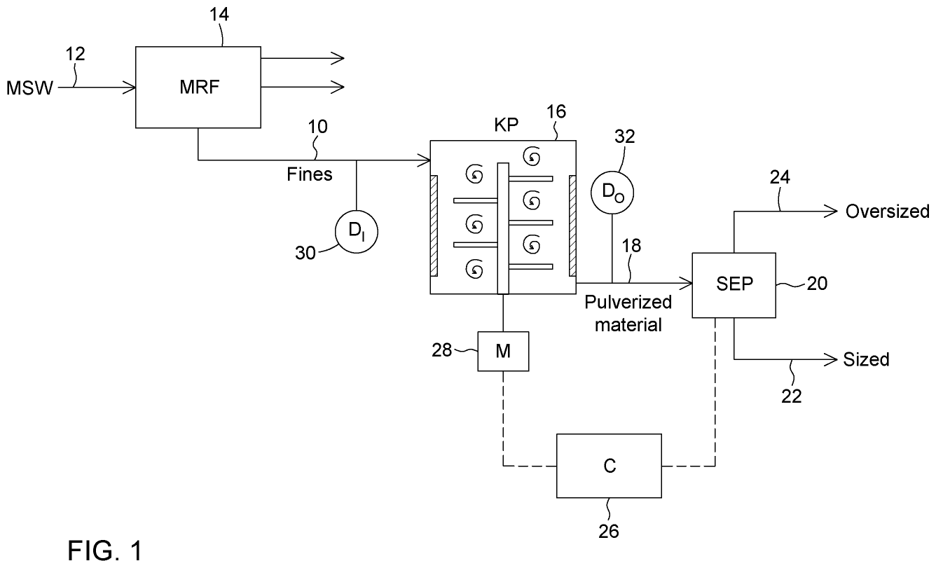

Referring to FIG. 1, a fines stream 10 that is derived from the processing of municipal solid waste (MSW) 12 and/or generated in a materials recovery facility (MRF) 14 is subjected to kinetic pulverization 16 to produce a pulverized output stream 18. The fines stream 10 includes ductile material and breakable material. The breakable material is typically hard, brittle or friable such that the kinetic pulverization facilitates notable size reduction, converting the breakable material into a sized reduced fraction. The breakable material is size-reduced, for example to sand or silt sized particles, and is homogenized with the pulverized output stream 18. Examples of breakable materials include glass, ceramics, drywall, shingles, rocks and aggregates, as well as organics such as food and yard waste in addition to woods that are not necessarily hard but are friable and sized-reduced. The ductile material, on the other hand, is softer and not significantly sized reduced by the kinetic pulverization 16. Examples of the ductile material include plastic film, fibers, hard plastics and soft plastics. Thus, the pulverized output stream 18 includes a sized-reduced fraction composed of a broken-down fraction, and a larger ductile fraction.

The pulverized output stream 18 can then be subjected to separation 20 to recover a sized-reduced stream 22 largely composed of the broken-down fraction, and an oversized material stream 24 largely composed of the larger ductile fraction. The separation step 20 can be performed in one or more stages, and can use a variety of separation equipment. For example, various types of screens can be used, such as a vibrating screen and/or a trommel screen. Other types of separation equipment can also be used. The separation equipment could be new and dedicated for the fines treatment process described herein, or could be part of an existing separation stage in the facility. In some implementations, the pulverized output stream 18 is subjected to separation to produce more than two streams that may have various properties that aid separation and enable downstream repurposing or disposal. The separation stage can, for example, include multiple separators (e.g., screens) arranged in parallel or in series.

Regarding the feedstock that is supplied to the kinetic pulverization stage 16, it can be a fines stream that is generated in an MRF and would conventionally be disposed of without further processing or recovery. The MRF receives, separates and prepares recyclable materials for marketing to end-user manufacturers, and can be a source separated single stream MRF or a mixed waste or “dirty” MRF. The composition of the fines stream can vary and will depend on the composition of the waste material received by the MRF as well as the processing equipment and operation of the MRF. The feedstock can also be a fines stream within a composting facility or another types of waste treatment facility, for example.

The following examples of feedstock fines streams can be processed using the process described herein and used to produce size-reduced streams. The feedstock includes sized material, pre-conditioned from a sorting and/or processing system, compost facility, or MRF where the input is mixed waste (e.g., MSW), source separated recyclables (e.g., single-stream), construction and demolition debris, yard waste, food waste, or other commingled waste streams. It is understood that the MRF fines feedstock described herein may include pieces of construction and/or demolition debris that are in the mixed waste feedstock. However, it should be understood that in the present description the term “MRF fines” does not include a stream that is considered construction and demolition (C&D) fines recovered from a construction and demolition debris recovery operation.

Regarding mixed waste MRF fines, the average composition (% by weight) can be the following: organic matter (e.g., yard waste, food waste, dirt) up to approximately 50-70%; cellulosic matter (e.g., paper, diapers, tissues or the like) approximately 10-15%; broken glass approximately 8% to 12% or around 10%; metals from approximately 0.5% to 2%; plastics (rigid and film) approximately 10%-15%; and fabrics approximately 0-2%. Variations of these compositions can also occur where there is little to none of one or more of the component categories mentioned above. The sized-reduced streams generated from mixed waste MRF fines can include an organic concentrate product with 0.5-2% visible contaminants (e.g., metal, glass, plastic) with a size above 4 mm. The organic matter capture rate from the feedstock can be about 60-85% depending on factors such as screen configuration and material quality requirements. The oversized stream would be a mix of contaminants (e.g., plastic, metal, glass) and a small amount of oversized organic matter.

Regarding source separated single stream MRF fines/residue, the average composition (% by weight) can be the following: broken glass approximately 70-80%; organic matter (e.g., yard waste, food waste, dirt) approximately 0-5%; cellulose matter (e.g., paper, diapers, tissues or the like) approximately 5-10%; metals up to approximately 5%; plastics (rigid and film) approximately 5-10%; and fabric approximately 0-2%. Variations of these compositions can also occur where there is little to none of one or more of the component categories mentioned above. The sized-reduced streams generated from source separated single stream MRF fines can include pulverized glass below 50 mesh with less than 1% non-glass product. The glass capture rate from the feedstock can be greater than 97% depending on factors such as screen configuration and material quality requirements. The oversized stream would be a mixed non-glass material.

Regarding biomass compost overs, the average composition (% by weight) can be the following: biomass products approximately 65%-75%; glass and aggregate approximately 15-20%; and plastic up to approximately 5%. The sized-reduced streams generated from biomass compost overs can include an organic concentrate with 0.5-2% visible contaminants (e.g., metal, glass, plastic) having a size above 4 mm. The organic matter capture rate from the feedstock can be at approximately 70-80% depending on factors such as screen configuration and material quality requirements. The oversized stream would be a mix of contaminants (e.g., plastic, metal, glass) and oversized organic matter.

Regarding construction and demolition (C&D) fines, the average composition (% by weight) can be the following: aggregate (e.g., rock, brick, concrete, ceramics, glass, dirt) of approximately 50-70%; cellulose matter (e.g., cardboard, fiber board, paper) approximately 5%; wood approximately 5-15%; gypsum: approximately 20-40%; metals approximately 0.5-1%; and plastics approximately 5%. The sized-reduced streams generated from C&D fines can include inert, soil-like concentrate with up to 0.5% visible contaminants (e.g., metal, glass, plastic) with a size over 4 mm. The refuse stream can be a mix of visible contaminants (e.g., plastic, metal, glass) and oversized organic matter (e.g., wood).

In addition, the fines stream 10 can be fed directly to the kinetic pulverization stage 16 without pre-treatment, such as drying pre-treatment, as the kinetic pulverizer is capable of effectively handling wet feed material. For example, the fines stream can have a moisture content of up to 50% or between 10% and 40%, and can be fed directly into the kinetic pulverizer without pre-drying. For wetter fines streams having a moisture content over 50%, a pre-drying step can be performed to dry the material below 50%.

Various infeed feedstocks can be envisioned for the process. One example feedstock is commingled or complex material streams-typically derived from municipal, commercial or industrial solid wastes—that have been pre-processed or screened to remove recyclable content and/or items exceeding 2 inches (although 3 inch minus, 4 inch minus or higher is also possible) that have limited use or negative value, usually destined for disposal. Example types include screenings from mixed waste processing facilities, single stream recycling facilities, construction and demolition debris processing plants, and composting facilities, which contain a combination of hard/brittle and soft/ductile components-commonly referred to as “fines”, “rejects”, or “residual” material. Another example feedstock is glass including pane and/or laminated glass where the pulverization stage allows liberation of glass and film lamination layer in one pass and then separation through sizing and separation equipment in one step. Another example feedstock includes compost overs where the pulverization stage allows recovery of clean organic content through conventional sizing equipment in one step. Compost overs is a compost material (either finished or unfinished) that includes some plastic film and glass, and thus it can benefit from the size reduction, homogenization of size-reduced particles, liberation of oversized material, and separation facilitated by the present process to remove the oversized plastics and obtain a valuable sized-reduced material.

Regarding the kinetic pulverization stage, a single kinetic pulverizer can be implemented and operated as a one-pass stage. For example, the feedstock can be fed into an upper part of the kinetic pulverizer, which includes a drum with baffles and an internal rotating stem with multiple arms that create vortexes within the drum chamber. The feed material passes into the vortices and experience self-collision for size reduction of the breakable material. The material passes to a bottom region of the kinetic pulverizer and is expelled via a lower outlet as the pulverized output stream 18. The rotation speed can be operated between 500 RPM to 1,200 RPM or between 600 RPM and 1,100 RPM or between 700 RPM and 1,000 RPM, and can be adjusted in response to other process parameters or maintained relatively constant. In some implementations, the rotation speed is adjusted to control the size and quality of the output material.

In some cases, the process, kinetic pulverization stage 16 and/or kinetic pulverizer 50 can be operated in continuous mode or in semi-batch mode. It is also possible to pulverize the material in a single pass or using multiple passes through the kinetic pulverizer 50. When multiple passes are used, the pulverized material from a first pass can be screened and only a fraction fed through a subsequent pass. More generally, certain materials or fractions can be subjected to multiple pulverization stages, which may be done in the same kinetic pulverizer 50 via recycling. Each pass through the kinetic pulverizer 50 may be done at the same or different operating conditions (e.g., rotation speed, feed rate) where variations in operating conditions are determined based on the composition of the feed for each pass, for example.

The kinetic pulverization stage can not only enable targeted size reduction of the breakable material, but can also facilitate drying and pathogen reduction for a higher quality output stream. For example, the overall process including kinetic pulverization and separation can produce a sized material that has a moisture content 30% (or 15% to 25%) lower than the infeed waste material. In some implementations, the pulverizing stage reduces the moisture by 5-8% and then the separation stage enables the sized fraction to have a further lowered moisture content. In addition, the pulverization stage can facilitate air stripping of the feedstock material which can, in turn, result in pathogen reduction.

The kinetic pulverization stage 16 can facilitate the use of kinetic energy, vortices and matter-on-matter collisions to achieve size reduction of the breakable material, homogenization of the broken-down material, liberation and separation of ductile material, blending of additives that may be incorporated, drying, pathogen reduction. For streams having certain features-mixed materials, moisture, pathogens, etc.—the one-pass kinetic pulverization can facilitate efficient treatment and recovery of materials.

Regarding the pulverized output stream 18, in some implementations the pulverization stage 16 generates material that ranges from dust-sized particles to larger particles, with the majority (e.g., over 50% or between 50% and 70% or even over 90%) passing a ⅜ inch sieve. Oversized material includes the lower density, flexible fraction of feedstock, while pulverizing of the breakable material-which is brittle, hard, friable-homogenizes this size-reduced fraction to facilitate liberation and separation from the larger ductile fraction through various separation technologies that can include screening. The oversized fraction can be substantially composed of plastic materials and can also include other materials, such as fibers, film, metal, and so on.

Regarding the separation stage 20, the oversized fraction can be separated from the sized fraction using a size-based separation technique, such as screening. The screening can be performed using various types of mechanical screens, such as a vibrating screen, a tumbler screen, a trommel screen, among others. The mechanical screen can be configured or operated based on the composition and size distribution of the pulverized output stream 18 to favour separation of the sized and oversized fractions from each other. The screen can be provided to favour or maximize high purity or high yield of the oversized stream (e.g., plastics), or to favour other parameters related to the separated streams 22, 24. The separated streams 22, 24 can then be subjected to further processing and recovery, if desired.

In some implementations, the separation stage 20 and the pulverization stage 16 are coordinated such that the operation of one can influence the other. For example, the screen and the pulverizer can be monitored and controlled via a controller 26 to achieve a desired parameter, such as certain properties of the separated streams 22, 24. For example, if a change in the input feedstock results in the pulverizer generating a larger sized-fraction in the pulverized stream 18, the screen can be controlled accordingly to favour a certain desired separation. In addition, the pulverizer can be controlled, e.g., to increase the rotation speed by controlling the motor 28, to bring the sized fraction back to within a target range to facilitate a desired separation. Monitoring instrumentation, such as an inlet detector DI 30 and an outlet detector Do 32, can be provided to monitor properties of the streams (e.g., size distribution, composition, mass and/or volume flow rates). Depending on the sized product to be produced, the screen and the kinetic pulverizer can be operated and designed in certain ways to generate a product having a maximum size, for example. When glass is the dominant component of the sized material, the screen can be 50 mesh and the kinetic pulverizer operates to size reduce the glass below 50 mesh. When organics are a dominant component of the sized material, the screen can be ⅜ inch or ½ inch. For compost applications, the screen could be ½ inch or ¼ inch, for example. However, it is noted that the screen design can be market driven to provide various size distributions of the size-reduce material.

In some implementations, the various streams are transported between stages using conveyor systems to facilitate continuous operation, although other transport methods can be used. The process can be continuous, batch feed, or operated according to other schemes depending on the facility and other factors.

Regarding the kinetic pulverizer, it is noted that the unit can have various structural and operational features. It some implementations, the kinetic pulverizer can have one or more features as described in PCT/CA2019/050967, which is incorporated herein by reference.

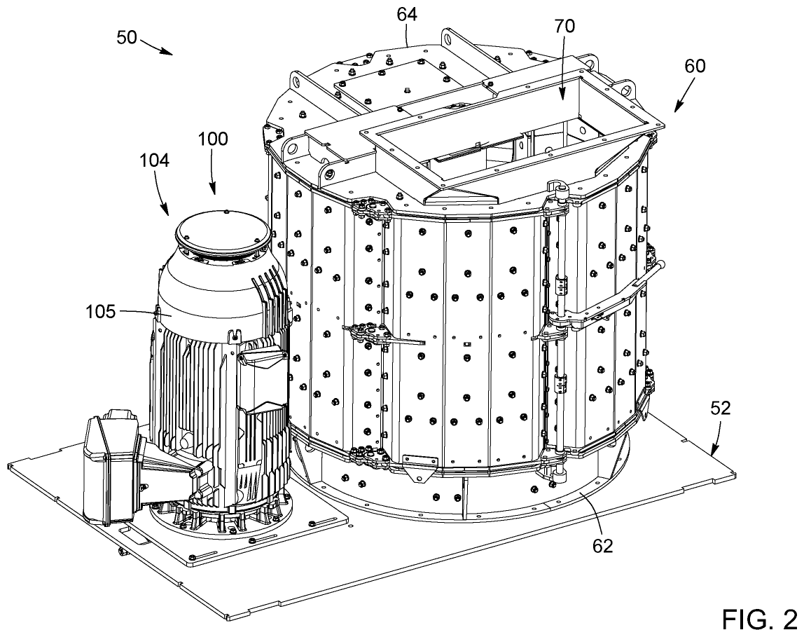

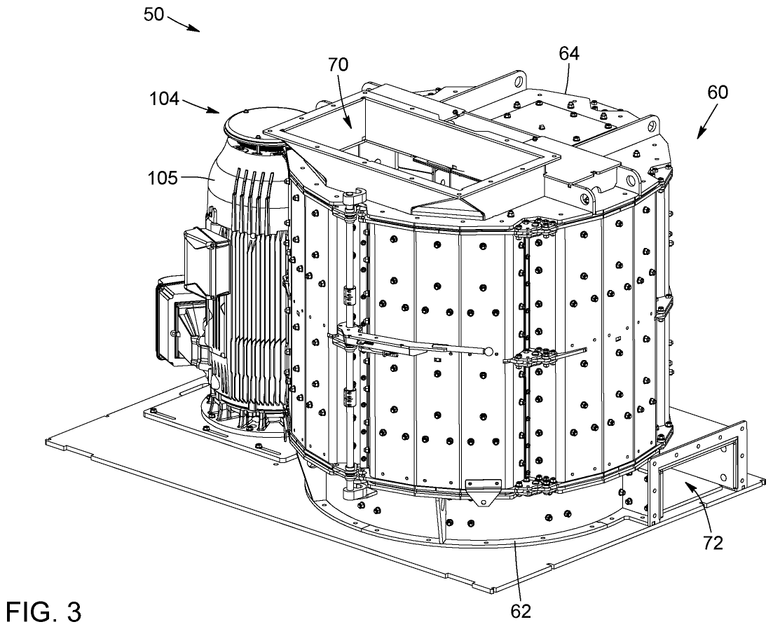

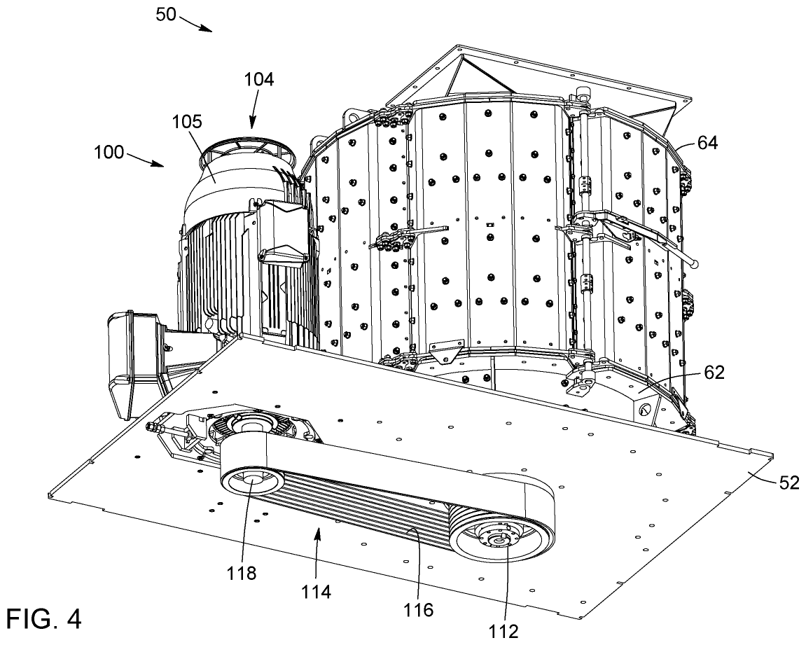

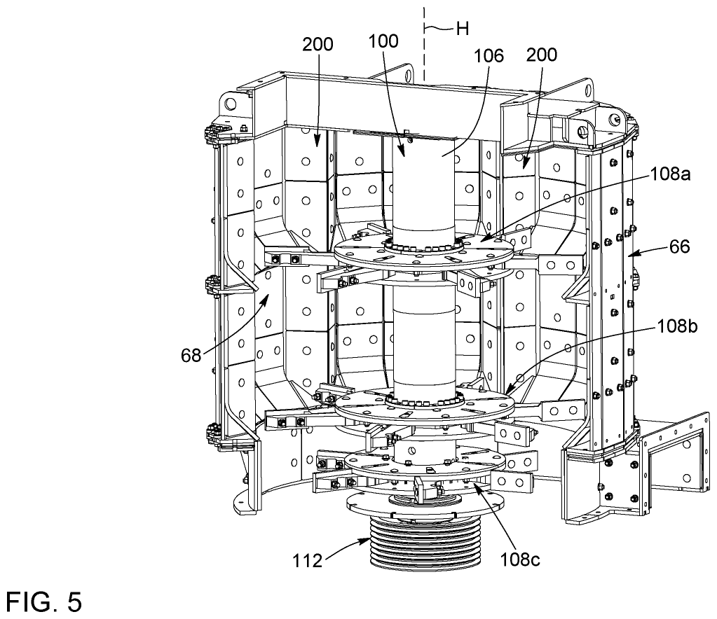

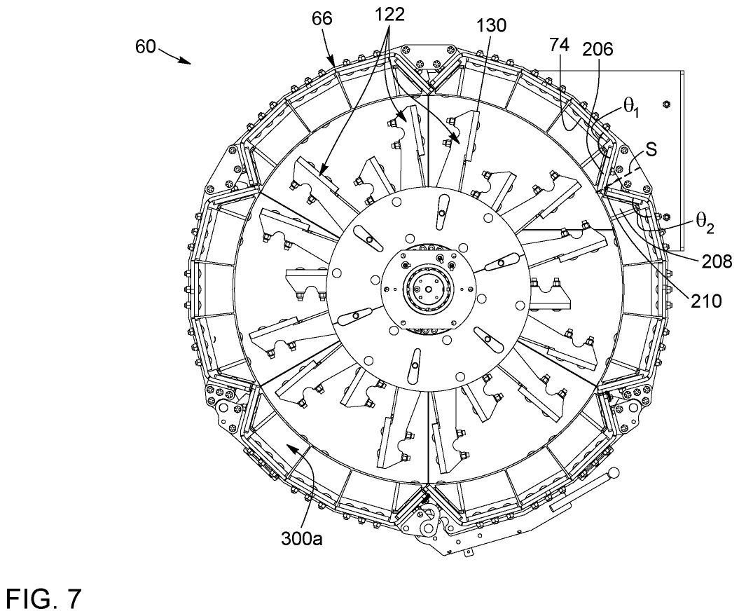

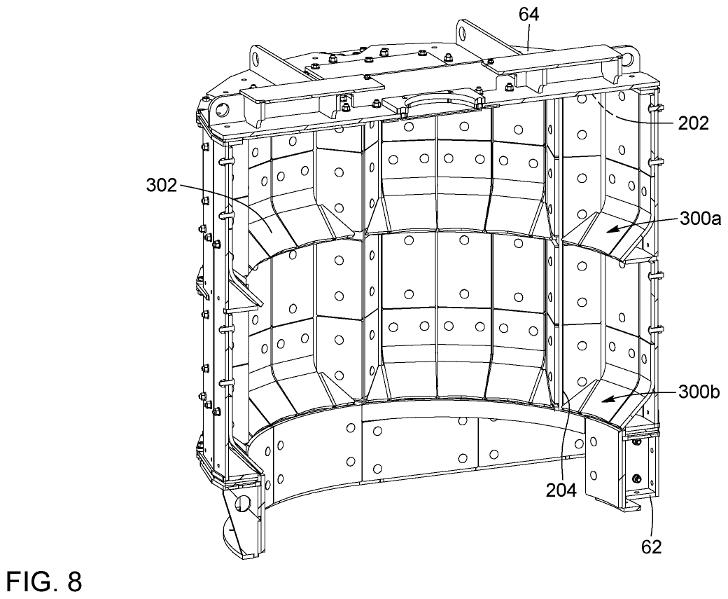

Referring now to FIG. 2 to FIG. 10, there is shown a pulverizer 50, in accordance with one embodiment. The pulverizer 50 is adapted to receive an input material as described herein and to pulverize or comminute the input material.

It will be understood that the terms “pulverize”, “pulverization”, “comminute” and “comminution” are used herein to refer to a reduction in size of the particles in the input material.

In the illustrated embodiment, the pulverizer 50 includes a base 52 and a housing 60 mounted over the base 52. Specifically, the housing 60 includes a bottom end 62 connected to the base 52 and a top end 64 opposite the bottom end 62. The housing 60 is hollow and includes a housing sidewall 66 extending between the top and bottom ends 64, 62 to define an interior chamber 68 in which the pulverization occurs. Specifically, the housing 60 includes an inlet 70 located at the top end 64 to receive the input material and an outlet 72 located at the bottom end 62 through which the pulverized material may be discharged once having been pulverized in the interior chamber 66. In the illustrated embodiment, the outlet 72 allows pulverized material to be discharged in a tangential direction to the housing sidewall 66. It will be understood that the outlet 72 may be configured differently. For example, the outlet 72 may be located in a bottom face of the housing 60 such that the pulverized material may be discharged in an axial direction downwardly from the housing 60. It will also be understood that alternatively, the outlet 72 may be positioned substantially towards the bottom end 62 but may not be positioned exactly at the bottom end 62 of the housing 60. Similarly, the inlet 70 may not be positioned exactly at the upper end 64 of the housing 60 and may instead be located generally towards the upper end 64.

In the illustrated embodiment, the housing 60 is generally cylindrical and defines a central housing axis H extending between the top and bottom ends 64, 62 of the housing 60. The housing 60 is adapted to be disposed such that the central housing axis H extends substantially vertically when the pulverizer 50 is in operation. In this configuration, the input material fed into the inlet 70 will ultimately tend to fall down towards the outlet 72 by gravity.

In the illustrated embodiment, the airflow generator 100 includes a pulverizing rotor assembly 102 disposed within the interior chamber 68 and a rotary actuator 104 operatively coupled to the pulverizing rotor assembly 102 for rotating the pulverizing rotor assembly 102 in order to generate the airflow. Specifically, the pulverizing rotor assembly 102 includes a rotatable shaft 106 located in the interior chamber 68 and extending between the top and bottom ends 64, 62 of the housing 60, along the central housing axis H, and a plurality of pulverizing rotors 108a, 108b, 108c secured to the rotatable shaft 106 so as to rotate about the central housing axis H when the rotatable shaft 106 is rotated.

Each pulverizing rotor 108a, 108b, 108c includes a rotor hub 120 and a plurality of rotor arms 122 extending outwardly from the rotor hub 120 and towards the housing sidewall 66. The rotatable shaft 106 extends through the rotor hub 120 such that the rotor arms 122 are disposed in a rotation plane R which extends orthogonally through the central housing axis H. In this configuration, when the rotatable shaft 106 is rotated, the rotor arms 122 therefore remain in the rotation plane R and move along the rotation plane R. Alternatively, instead of all being disposed in a rotation plane, the rotor arms 122 could instead be angled upwardly or downwardly relative to the rotatable shaft 106. In yet another embodiment, the rotor arms 122 could instead be pivotably connected to the rotatable shaft 106 such that the rotor arms 122 could selectively be angled upwardly and downwardly as desired, either manually or automatically using one or more arm actuators.

In the illustrated embodiment, the plurality of airflow deflectors 200 includes six deflectors 200 which are substantially similar to each other and which are substantially evenly spaced from each other in an azimuthal direction (i.e. along a circumference of the housing sidewall 66) around the central housing axis H. Alternatively, all the deflectors 200 may not be similar to each other, may not be spaced from each other evenly and/or the pulverizer 50 may include more or less than six deflectors 202. For example, the pulverizer 50 may include between two and eight deflectors 200.

In the illustrated embodiment, each deflector 200 is elongated and extends substantially parallel to the housing axis H. Specifically, since the housing 60 is positioned such that the central housing axis H extends substantially vertically, the deflectors 200 also extend substantially vertically.

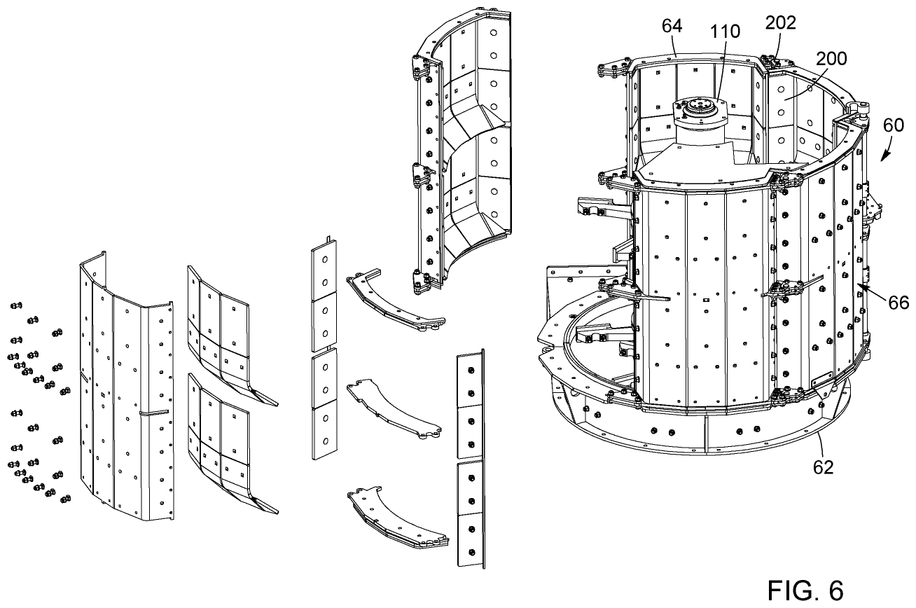

As best shown in FIGS. 6 to 8, each deflector 200 includes a top end 202 located towards the top end 64 of the housing 60 and a bottom end 204 located towards the bottom end 62 of the housing 60. In the illustrated embodiment, each deflector 200 is positioned so as to intersect the rotation plane R of the upper pulverizing rotor 108a and of the intermediate pulverizing rotor 108c. More specifically, the top end 202 of the deflectors 200 is located above the upper pulverizing rotor 108a while the bottom end 204 of the deflectors 200 is located below the intermediate pulverizing rotor 108c, and the deflector 200 extends continuously between its top and bottom ends 202, 204.

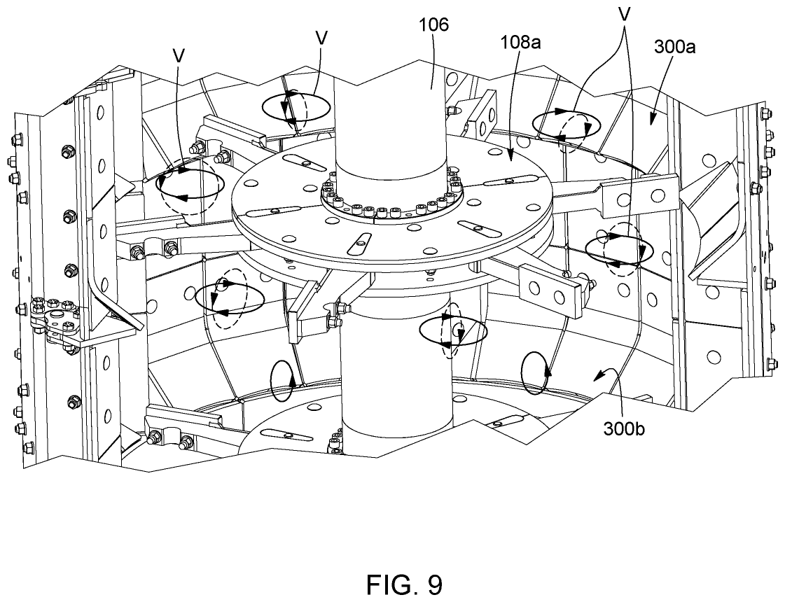

It will be understood that rotation of the rotor arms 122 will cause the air within the interior chamber 68 to move outwardly towards the housing sidewall 66. In the above configuration, since the deflectors 200 are horizontally aligned with the upper and intermediate pulverizing rotors 108a, 108c, the air will be moved outwardly by the upper and intermediate pulverizing rotors 108a, 108c against the deflectors 200 to be deflected by the deflectors 200 to form the vortices V, best shown in FIGS. 9 and 10.

In the illustrated embodiment, each deflector 200 is generally wedge-shaped. Specifically, each deflector 200 has a generally triangular cross-section and includes a flow facing deflecting surface 206 which faces towards the airflow when the rotatable shaft 106 is rotated and an opposite deflecting surface 208 which faces away from the airflow. The flow facing deflecting surface 206 and the opposite deflecting surface 208 extend away from the housing sidewall 26 and converge towards each other to meet at an apex 210 which points towards the housing central axis H. The flow facing deflecting surface 206 is angled relative to an inner face 34 of the housing sidewall 26 at a first deflection angle θ1 and the opposite deflecting surface 208 is angled relative to the inner face 74 of the housing sidewall 76 at a second deflection angle θ2.

In the illustrated embodiment, each deflector 200 is symmetrical about a symmetry axis S which extends along a radius of the housing 60. In this embodiment, the first deflection angle θ1 is therefore substantially equal to the second deflection angle θ2. In one embodiment, the first and second deflection angles θ1, θ2 may be equal to about 1 degree to 89 degrees, and more specifically to about 30 degrees to 60 degrees. Alternatively, the deflector 200 may not be symmetrical and the first and second deflection angles θ1, θ2 may be different from each other.

In the illustrated embodiment, the apex 210 of each deflector 200 is spaced radially inwardly from the inner face 74 of the housing sidewall by a radial distance of about 7¾ inches or about 20 cm. Still in the illustrated embodiment, the apex 210 is further spaced radially outwardly from a tip 130 of the rotor arms 122 by a radial distance of between about ½ inch or about 1 cm and about 2 inches or about 5 cm. In one embodiment, the radial distance or “clearance space” between the tip 130 of the rotor arms 122 and the apex 210 may be selected such that the vortices V may be formed as desired when the rotatable shaft 106 is rotated.

Alternatively, the deflectors 200 could be differently shaped and/or sized. For example, the flow facing deflecting surface 206 and the opposite deflecting surface 208 may not be planar, but may instead be curved. In another embodiment, the deflectors 200 may not comprise an opposite deflecting surface 208. In yet another embodiment, instead of being wedge-shaped, the deflectors 200 may instead have a rectangular cross-section, or may have any other shape and size which a skilled person would consider suitable.

FIG. 10 is a schematic representation of the vortices V generated within the interior chamber 68 when the pulverizer 50 is in operation.

During operation of the pulverizer 10, the rotatable shaft 106 is rotated about the housing axis H such that the rotor arms 122 form the circular airflow revolving about the housing axis H. In the example illustrated in FIG. 10, the rotatable shaft 106 is rotated in a clockwise direction when viewed from above to form a counterclockwise airflow in the interior chamber 68.

The rotatable shaft 106 may be rotated at relatively high speed to provide the desired pulverizing effect in the pulverizer. In one embodiment, the rotatable shaft 106 is rotated at a rotation speed of between about 700 rpm and about 1100 rpm, and more specifically at a rotation speed of between about 1000 rpm and about 1100 rpm. Alternatively, the rotatable shaft 106 may be rotated at a different rotation speed which would allow the formation of the vortices as described below.

The airflow travels generally along the inner face 34 of the housing sidewall 66, but is interrupted by the flow facing deflecting surface 206 of the deflectors 200 which cooperates with the rotor arms 122, and more specifically with the tip of the rotor arms 122 to form the vortices V. As shown in FIG. 10, the vortex V may further be guided back inwardly towards the central housing axis H by an adjacent deflector 200′.

Still referring to FIG. 10, each vortex V further overlaps at least one adjacent vortex V1, V2 to cause input material particles in suspension in the vortex V to collide with input material particles in suspension in the adjacent vortex or vortices V1, V2. More specifically, each vortex V created generally includes an outwardly moving portion 500 defined generally by airflow circulating from the shaft 106 towards the housing sidewall 66 and an inwardly moving portion 502 defined generally by airflow circulating from the housing sidewall 26 towards the shaft 106. As shown in FIG. 10, the outwardly moving portion 500 of each vortex V overlaps the inwardly moving portion 502 of a first adjacent vortex V1, and the inwardly moving portion 502 of each vortex overlaps the outwardly moving portion 500 of a second adjacent vortex V2.

In this configuration, the input material particles in the vortex therefore collide with input material particles moving at twice the movement speed of the particles in the vortex V. For example, in one embodiment, the vortices V, V1, V2 are rotating at about a third of the speed of sound. When input material particles from the first and second adjacent vortices V1, V2 collide with the input material particles in suspension in the vortex V, which move at the same speed but in the opposite direction, the particles will collide with each other at about two thirds of the speed of sound.

In one embodiment, in addition to the collision of the input material particles via the airflow and vortices V, the input material may further be pulverized by the rotor arms 122 impacting the input material particles in the interior chamber 68 as the rotatable shaft 106 is rotated. In this embodiment, the combined effect of the input material particles impacting each other in the overlapping vortices V, V1, V2 and of the rotor arms 122 impacting the input material particles may increase the efficiency of the pulverizer. Moreover, since the overlapping vortices V cause the particles to impact each other rather than surfaces inside the housing 20, the wear of the components inside the housing 20 may be reduced.

It will be understood that the vortices V illustrated in FIGS. 9 and 10 have been simplified for ease of understanding and that in practice, the vortices V may not be exactly circular as illustrated or be exactly located as indicated in FIG. 10.

In the illustrated embodiment, the pulverizer 50 further includes a plurality of shelves 300a, 300b which extend inwardly from the housing sidewall 26. Specifically, the plurality of shelves 300a, 300b includes an upper shelf 300a and a lower shelf 300b spaced downwardly from the upper shelf 300a. Each shelf 300a, 300b extends circumferentially around the housing axis H and along the housing sidewall 26. It will be understood that the shelves therefore extend substantially orthogonally to the deflectors 200. Specifically, the deflectors 200 extend generally parallel to the housing axis H and can therefor be said to extend in an axial direction relative to the housing 60, while the shelves can be said to extend in an azimuthal direction relative to the housing 60. In the illustrated embodiment, the deflectors 200 extend generally vertically while each shelf 300a, 300b is disposed in a generally horizontal plane and therefore extend generally horizontally.

Still in the illustrated embodiment, each shelf 300a, 300b extends substantially continuously around the housing sidewall 66. Alternatively, the shelves 300a, 300b may not extend continuously around the housing sidewall 66 and could instead include a plurality of shelf segments spaced from each other to define gaps between adjacent shelf segments.

In the illustrated embodiment, the upper shelf 300a is substantially horizontally aligned with the upper pulverizing rotor 108a and the lower shelf 300b is substantially horizontally aligned with the intermediate pulverizing rotor 108c. Alternatively, each shelf 300a, 300b could be located slightly below the corresponding pulverizing rotor 108a, 108c.

In the illustrated embodiment, each shelf 300a, 300b includes a top shelf face 302 which extends downwardly and away from the housing sidewall 66. Specifically, since the shelf 300a, 300b extends along the housing sidewall 66 and around the housing axis H, the top shelf face 302 is substantially conical. Still in the illustrated embodiment, the top shelf face 302 is angled relative to the housing sidewall 66 at an angle of between about 1 degree, where the top shelf face 302 would be almost flat against the housing sidewall 66, and about 89 degrees, where the top shelf face 302 would be almost orthogonal to the housing axis H. In one embodiment, the top shelf face 302 could be angled relative to the housing sidewall 66 at an angle of between 30 degrees to 60 degrees.

The shelves 300a, 300b are configured to deflect the airflow directed towards the shelf upwardly. This allows the input material particles to be temporarily maintained in suspension above the shelf 300a, 300b. The input material particles can therefore be subject to the effect of the vortices and to pulverization by impact with the rotor arms 122 for a longer period of time, resulting in additional reduction in the size of the input material particles as they travel downwardly towards the next rotor stage or towards the outlet 72.

The upward deflection of the airflow may further contribute to the vortices V within the interior chamber 68. More specifically, as shown in FIG. 9, the vortices V may rotate in a plane generally parallel to the housing axis, i.e., upwardly-downwardly, in addition to rotating in a plane orthogonal to the housing axis H as illustrated in FIG. 10. The combined effect of the shelves 300a, 300b and the deflectors 200 therefore contribute to forming vortices V which are tridimensional such that air within the vortices V moves along a tridimensional path of travel, which may further promote collisions between the input material particles of adjacent, overlapping vortices V.

This configuration further allows the number of vortices V generated by the deflectors 200 to be multiplied by the number of shelves 300a, 300b in the housing 60. For example, in the illustrated embodiment, the pulverizer 50 includes six deflectors 200 which can form six vortices above each shelf 300a, 300b, for a total of 12 vortices in the entire interior chamber 68.

The pulverizer can be designed and sized to handle the fines stream for one-pass processing. For example, the pulverizer can be sized to handle 5 to 20 tonnes per hour, or 10 to 15 tonnes per hour, of a waste stream that comprises a mixture of components as described above, while operating as a one-pass unit with a rotation speed between 500 RPM and 1,200 RPM to produce one or more of the output sized streams as described herein.

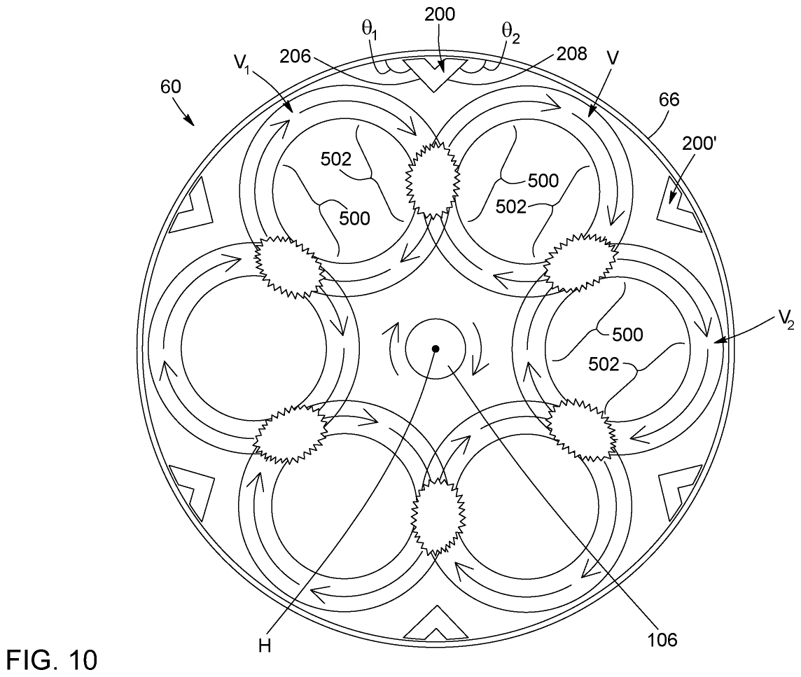

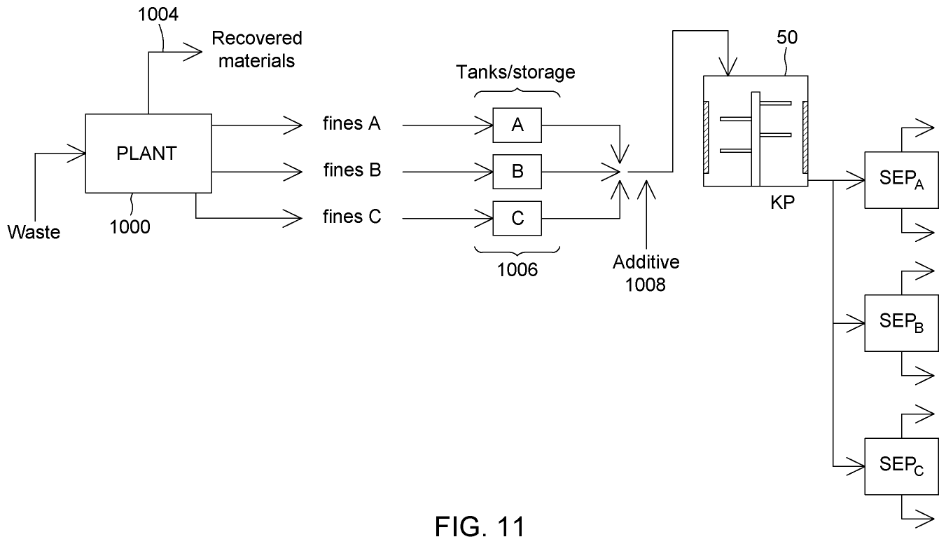

Referring to FIG. 11, it is also possible to provide a kinetic pulverizer 50 for one-pass operation and capable of processing various different feedstocks with no operational changes or with changes only related to rotation speed and/or feed rate. For instance, the kinetic pulverizer 50 could be implemented in a large plant 1000 that generates multiple different fines streams A, B, C to pulverize the fines streams at different times and produce respective output streams that can be subjected to separation which may occur in one screen or in respective screens that are designed for the given feedstock and end product to produce. Thus, a single kinetic pulverizer 50 along with one or more screens could be implemented in a plant that generates multiple residual fines streams A, B, C to facilitate production of various end products. FIG. 11 shows a plant 1000 that receives waste 1002 and generates recovered materials 1004, as well as at multiple fines or residual streams A, B, C that are supplied to respective tanks or storage locations 1006. Alternatingly, one of the fines streams is supplied to the pulverizer 50, and is optionally combined with a friable additive 1008 as described above. The pulverizer generates a pulverized output stream that is supplied to a corresponding screen A, B or C to produce the corresponding size-reduced material. In this manner, a single pulverizer can be used to upgrade multiple fines streams generated by a waste processing plant 1000.

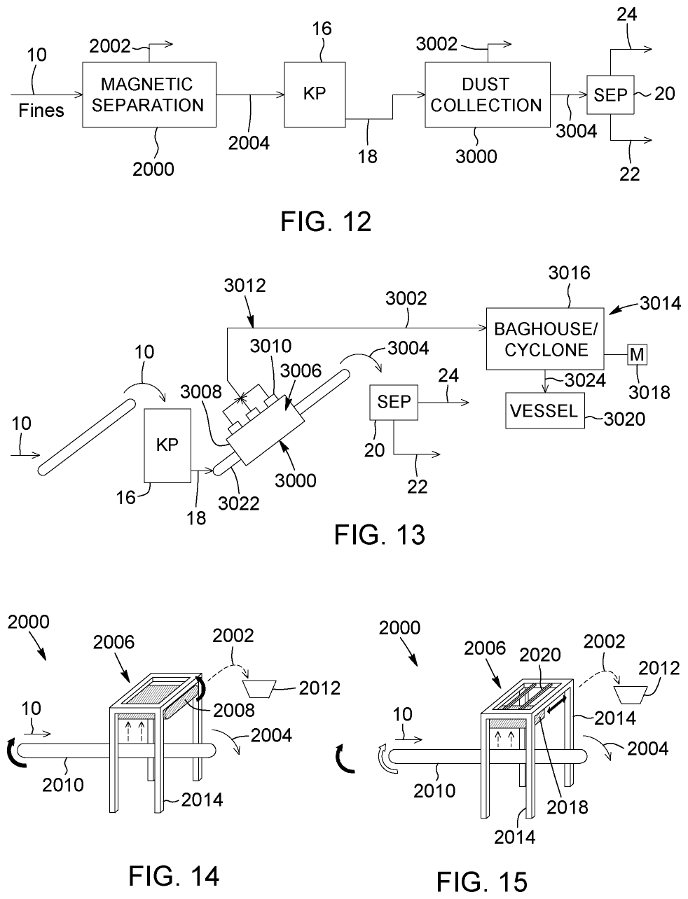

Referring now to FIG. 12, in some embodiments the process includes a magnetic separation stage 2000 upstream of the kinetic pulverization stage 16 to capture ferrous metal from the fines stream 10. The separated metal 2002 can be supplied as scrap metal for resale or can be disposed of. The metal depleted fines stream 2004 can be fed to the kinetic pulverization stage 16. The magnetic separator can be designed and operated to remove tramp metal with a high weight density to reduce wear and damage on the KP. For example, the magnetic separator can be provided based on nominal size of the feedstock and ferrous objects that would be desirable for removal. For instance, the magnetic separator can be provided to ensure removal of solid ferrous objects that have a high weight in an overall low volume. While some geometries, such as flat sheets, may pose little concern to the operation of the KP, other geometries such as blocks, chunks, and the like can increase wear and damage and thus the magnetic separation stage 2000 facilitates removal to enhance downstream processing. The magnetic separator can be configured based on size of the feedstock, ferrous object size, and material burden depth. The magnetic separator could be actively controlled or simply turned on to enable the separation. The magnetic separation stage 2000 facilitates reduced risk of wear and damage to the KP stage 16, and also diverts more waste from going to landfill by recovering scrap metal material.

The magnetic separation stage 2000 can use various types of magnetic separators which can be selected based on the feedstock and throughput. For example, the magnetic separator can be a dry-type magnetic separator or wet type magnetic separator depending on the moisture content of the feedstock. The magnetic separator can have a magnetic field strength that is designed for removal of target ferrous metal objects that could be problematic for the KP stage 16. The magnetic separator could also include a permanent magnet and electromagnetic magnetic separator. The magnetic separator can also have various design and structural features, e.g., drum type, roller type, disc type, ring type, belt type, among others. The magnetic separator can also use constant, alternating, pulsating, or rotating magnetic fields depending on the design and configuration of the system and the feedstock. The magnet itself can be composed of various materials.

While magnetic separation is a preferred mechanism to remove metals from the feedstock, there are various other metal removal methods that could be used instead of or in addition to magnetic separation. An additional metal removal stage could be designed to remove non-ferrous metals, for example, particularly metal debris that has a high weight density and are thus relatively heavy and thick. In some implementations, the metal removal method (e.g., magnetic separation) is performed to remove all metal debris having an average diameter of 1 inch or greater. Metal debris that is lump shaped or elongated is removed, while metal debris that has a flat sheet shape is optionally removed.

Referring now to FIGS. 13 and 14, two example configurations are shows for the magnetic separation stage 2000. FIG. 13 shows a belt magnetic separator 2006 including a self-cleaning magnetic belt 2008 that is above a conveyor 2010. The magnetic belt 2008 discharges the ferrous metals into a bin 2012. The magnetic belt 2008 can be mounted to a magnet frame 2014 that spans across the conveyor 2010. FIG. 14 shows an alternative configuration including a stationary magnet 2018 on rails 2020 mounted above the conveyor 2010 and configured to move back and forth.

Referring still to FIG. 12, the system can also include a dust collection stage 3000 for recovering dust that is part of the pulverized output stream 18 exiting the KP stage 16. The pulverized output stream 18 enters the dust control stage 3000 which recovers a dust stream 3002 and produces a dust reduced pulverized stream 3004 that is fed to the separation stage 20. The dust collection stage 3000 facilitates dust control and can include various units, such as a setting chamber and a baghouse or cyclone filtration unit.

Referring to FIG. 13, the dust collection stage 3000 can include a dust collector 3006 that is coupled to the exit of the KP stage 16 and may include a settling chamber 3008 that has dust outlets 3010 positioned on its top. The dust outlets can be in fluid communication via ducting 3012 to a dust recovery unit 3014 that includes a baghouse or cyclone filtration unit 3016 having a dedicated motor 3018. The dust recovery unit 3014 can also include a dust recovery vessel 3020 that receives the dust from the baghouse or cyclone filtration unit, for example via a hopper.

The settling chamber 3008 can receive all of the output from the KP stage 16 and thus receives relatively fine particles which are deposited on an outfeed conveyor 3022 so that the fines are added to the diverted output. Fine particles settle on the outfeed conveyor 3022, while very fine dust particles are accumulated and withdrawn from the settling via the dust outlets 3010. The setting chamber 3008 can extend over a part or the entire length of the outfeed conveyor 3022 depending on the process design and the target level of dust control. The setting chamber 3008 can be in communication with the outlet of the KP unit via a flexible tubular member since the KP unit can experience vibration.

The quantity of dust in the pulverized output stream 18 is highly dependent upon the type and dryness of the feedstock supplied to the KP stage 16. For instance, output diversion rates as high as about 30% have been observed for some feedstocks, while for MWS fines the diversion rate is much lower. With feedstocks such as C&D material, diversion rates will be higher.

It is noted that the power and suction of the dust collection stage 3000 can be adjusted to increase the amount of material capture in the dust collector. For example, the dust recovery unit 3014 can be controlled to provide a desired suction in the dust collector 3006. Therefore, the dust collection stage 3000 can be designed and operated to be a tool in the separation of the outbound material from the KP stage 16. It is also noted that the dust collector 3006 can also pick up plastic film pieces, which are relatively light, and such plastic film pieces can therefore be separated by both the separate stage 20 and the dust collection stage 3000.

Still referring to FIG. 13, the baghouse filtration or cyclone filtration 3016 traps finer and lighter material, which can be stored in the vessel 3020. This fine recovered material 3024 can be added back into the diverted output stream, disposed of and/or kept as a fines product for sale. The fine recovered material 3024 can be recycled back into one or more stages of the system. Preferably, the fine recovered material 3024 would be supplied into the dust reduced stream 3004 or the size-reduced stream 22, or would be kept as a distinct product stream that could be sold or mixed with other materials to provide a commercial product. It is noted that the recovered dust material can be treated, transported and used in various ways, some of which are described herein.

### EXPERIMENTATION

Comparative experiments were conducted on an MRF fines material obtained from an MSW processing plant. The MRF fines taken as feedstock was below 2½ inch material and samples were subjected to size reduction in a kinetic pulveriser as described herein as well as in a grinder device (Rotochopper®). The size-reduced material was then subjected to ½ inch screening to obtain a screened fraction and an oversized reject fraction. A vibration screen was used for the comparative tests.

In terms of observations and results, the quality and the yield of the screened fraction when using the KP were notably higher compared to the grinder device. In addition, for the KP less organic material reported with the reject oversized fraction compared to the grinder device.

For example, with the KP the rejects in the screened fraction represented a percentage of 11%; for the grinder, 21%. This means that undesirable materials were excessively size reduced by the grinder such that they tended to pass through the screen with the desirable material such that the quality of the product was inferior compared to the KP. In contrast, the KP facilitated liberation and separation of such undesirable materials resulting in a higher quality screened product. In the tests, the KP facilitated production of a screened fraction with almost half the amount of undesirable materials compared to the grinder tests.

In addition, for the KP the proportion of man-made objects such as glass, ceramic, plastics, etc., in the reject material was 4.5%; for the grinder, 8.1%. This indicates that the KP was able to size reduce hard man-made materials for inclusion in the screened fraction whereas the grinder was unable to achieve such size reduction and so a greater weight percentage of man-made objects reported to the oversized fraction.

Thus, the KP was able to size reduce organics and hard man-made objects such that almost 90% of the input MRF fines was size reduced and included in the screened product fraction. With the KP, very little organics were lost to the oversized fraction thus providing enhanced organics recovery for the final product.

The follow table provides a more detailed overview of the comparative test results with size distribution and contaminant composition data. The test results confirm that the use of the KP for processing feedstocks such as MRF fines facilitates several advantages.

| | KP | | Grinder | |
|---|---|---|---|---|
| | Size | | Size | |
| | reduced | | reduced | |
| | material | | material | |
| | before | Screened | before | Screened |
| Results | screening | fraction | screening | fraction |

Physical contaminants (%)

| | | | | |
|---|---|---|---|---|
| Total plastic > 4 mm | 2.2 | 0.4 | 1.1 | 1.6 |
| Film plastic > 4 mm | 0.63 | <0.1 | 0.4 | 0.4 |
| Glass > 4 mm | 0.43 | 0.81 | 2.4 | 2.1 |
| Metal > 4 mm | <0.1 | <0.1 | <0.1 | <0.1 |
| Sharps > 2 mm | Not | Not | Not | Not |
| | detected | detected | detected | detected |
| Total | 2.6 | 1.21 | 3.5 | 3.7 |

Size distribution (%)

| | | | | |
|---|---|---|---|---|
| >50 mm | 0.0 | 0.0 | 0.0 | 0.0 |
| 25-50 mm | 0.0 | 0.0 | 0.0 | 0.0 |
| 16-25 mm | 1.7 | 0.0 | 0.0 | 0.0 |
| 9.5-16 mm | 4.1 | 0.4 | 9.2 | 4.7 |
| 6.3-9.5 mm | 4.2 | 3.3 | 15.3 | 15.2 |
| 4.0-6.3 mm | 6.1 | 5.2 | 22.3 | 20.4 |
| 2.0-4.0 mm | 27 | 16.1 | 28.5 | 30.1 |
| <2.0 mm | 56.9 | 75.0 | 24.7 | 29.5 |

As can be noted from the table, the KP enabled a size distribution with much high proportions of smaller particles compared to the grinder. For example, with the KP, 75% of the screened material had a particle size below 2 mm, whereas only 29.5% of the screened fraction from the grinder was below 2 mm. In addition, the proportion of total plastics decreased due to screening of the KP size reduced material, whereas the proportion of total plastics increased for the grinder size reduced material. The film plastics were significantly reduced from screening for the KP size reduced material as the film plastics were liberated rather than overly sized reduced, whereas the proportion of film plastics stayed the same after screening the grinder size reduced material. In general, the contaminant concentrations were lower when using the KP for the size reduction stage.

1. A process for treating a fines stream in a material recover facility (MRF), comprising:
providing an MRF fines stream comprising:
breakable material comprising glass, ceramics, drywall, shingles, rocks and/or aggregates; and
ductile material comprising plastics;
subjecting the MRF fines streams to a one-pass kinetic pulverization stage wherein the fines stream is fed into a kinetic pulverizer and subjected to self-collisions created by vortices within the kinetic pulverizer to produce a pulverized material comprising a size-reduced fraction derived from the breakable material and an oversized fraction derived from the ductile material;
withdrawing the pulverized material from the kinetic pulverizer; and
subjecting the pulverized material to separation to produce a size-reduced stream and an oversized stream.

2. The process of claim 1, wherein the fines stream is derived from municipal solid waste (MSW) or source separated recyclables.

3. The process of claim 1, wherein the fines stream is a compost overs stream.

4. The process of claim 1, wherein the fines stream comprises material below 2 inches in size.

5. The process of claim 1, wherein the kinetic pulverizer is operated at a rotation speed between 500 RPM to 1,200 RPM.

6. The process of claim 1, wherein the kinetic pulverizer is operated at a rotation speed between 700 RPM and 1,000 RPM.

7. The process of claim 1, wherein the kinetic pulverizer is operated such that the size-reduced fraction is substantially sand or silt sized particles.

8. The process of claim 1, wherein the fines stream has a moisture content between 10% and 50% upon entry into the kinetic pulverizer.

9. The process of claim 1, wherein the fines stream has a moisture content between 15% and 40% upon entry into the kinetic pulverizer.

10. The process of claim 1, wherein the fines stream is not subjected to a drying stage upstream of the kinetic pulverization stage.

11. The process of claim 1, wherein the size-reduced fraction is a homogeneous mixture in the pulverized output stream.

12. The process of claim 1, wherein the kinetic pulverization stage effects water removal on the fines stream such that the water removal is between 5% and 8% in the kinetic pulverization stage.

13. The process of claim 1, wherein the kinetic pulverization stage and the separation enable the size-reduced stream to have a moisture content that is 5% to 30% lower than that of the fines stream.

14. The process of claim 1, wherein the kinetic pulverization stage effects pathogen reduction on the fines stream via air stripping.

15. The process of claim 1, further comprising incorporating a friable additive into the fines stream such that the friable additive is size reduced and is homogenized with the breakable material to form part of the size-reduced fraction.

16. The process of claim 15, wherein the friable additive comprises a porosity agent, a soil additive, a building material additive, a compost additive, peat moss, or a glass product additive.

17. The process of claim 15, wherein the friable additive is introduced into the fines stream upstream of the kinetic pulverization stage.

18. The process of claim 15, wherein the friable additive is introduced directly into the kinetic pulverizer as a separate stream from the fines stream.

19. The process of claim 1, wherein the separation stage comprises screening.

20. The process of claim 19, wherein the screening is performed using a trommel screen.

21.-76. (canceled)
